(19) United States
(12) Patent Application Publication
(10) Pub. No.: US 2025/0171171 A1
(43) Pub. Date: May 29, 2025

(54) SYSTEM AND METHOD FOR FILLING POUCHES WITH A MEDICAL LIQUID

(71) Applicant: Fresenius Kabi Deutschland GmbH, Bad Homburg (DE)

(72) Inventor: Torsten BRANDENBURGER, Bad Homburg (DE)

(21) Appl. No.: 18/730,673

(22) PCT Filed: Feb. 3, 2023
(86) PCT No.: PCT/EP2023/052662

§ 371 Date: Jul. 19, 2024

(30) Foreign Application Priority Data
Feb. 4, 2022 (EP) 22155202.9

(51) Int. Cl. B65B 3/00; B65B 3/04; B65B 39/00; B65B 39/12

(52) U.S. Cl. CPC B65B 3/003; B65B 3/045; B65B 39/12; B65B 2039/009

(57) ABSTRACT

A system for filling bags with a medical liquid is described. The system includes filling nozzles laterally mutually spaced from one another. The components of a medical liquid can be filled in a bag via one port each using the filling nozzles. A first filling nozzle is laterally movable with respect to at least one other filling nozzle.

### FIELD OF THE INVENTION

The invention relates to an installation and a method for filling bags with a medical liquid. In particular, the invention relates to the aseptic filling of bags with an infusion solution, in particular with an infusion solution for parenteral nutrition.

### BACKGROUND OF THE INVENTION

An installation for aseptically filling bags with a medical liquid is known from the published patent application WO 2015/044088 A1. According to the teaching of this document, the medical bag is filled under a protective atmosphere of nitrogen. This allows the filling process to be carried out in an aseptic environment. In this case, it may be possible to dispense with sterilising the bags in an autoclave.

Multi-chamber bags are used for parenteral nutrition compositions. Such multi-chamber bags are used in particular for infusion solutions for parenteral nutrition. The components of the nutritional solution, in particular carbohydrates, fats and amino acids as well as liquid with electrolytes, vitamins and trace elements are thereby filled into separate chambers of a bag.

Only immediately before the bag is used are the components mixed by opening pull-open weld seams between the individual chambers, for example by rolling and pressing the bag. The tear-open seams which separate the individual chambers from each other are designed to be torn open accordingly. A possible configuration of the seams is represented, for example, in WO 2006/010411 A1.

The different infusion solutions and the sometimes very different volumes mean that such infusion bags are available in a variety of designs, in which the ports for filling and removing liquid in particular have different spacings. In particular in paediatrics, three-chamber bags are used for a parenteral nutrition solution with a total volume of 500 ml or less.

It is therefore currently hardly possible to provide a single filling station that can be used for a large number of multi-chamber bags with different volumes without retrofitting.

### OBJECT OF THE INVENTION

The invention is therefore based on the object of at least reducing the aforementioned disadvantages of the prior art.

It is in particular an object of the invention to provide an installation for filling bags with a medical liquid, with which multi-chamber, in particular three-chamber bags can be filled, which have different volumes and possibly have a different port spacing from one another.

### SUMMARY OF THE INVENTION

The object of the invention is already achieved by an installation for filling bags with a medical liquid and by a method for aseptically filling bags with a medical liquid according to one of the independent claims.

Preferred embodiments and further developments of the invention can be inferred from the subject matter of the dependent claims, the description and the drawings.

The invention relates to an installation for filling bags with a medical liquid, with the installation comprising at least three, in particular four, filling nozzles which are arranged next to one another and laterally spaced apart from one another, with the components of a medical liquid being able to be filled into the bag or into a chamber of a bag via a port by means of the filling nozzles, with a first filling nozzle being able to be moved laterally relative to at least one further filling nozzle.

According to the invention, a filling nozzle can be adjusted in such manner that the installation can be adjusted, in particular automatically, to a different port spacing. In this way, starting from one valve block, the medical liquid can be filled into at least two, preferably exactly two different port receptacles. Such an installation can be used to fill in particular different multi-chamber bags, for example two- and three-chamber bags.

In particular, the installation is used for filling infusion bags, preferably infusion bags with a parenteral nutrition composition.

As described above, a multi-chamber bag comprises at least two, in particular three chambers, which are filled with a different medical liquid. For example, a first chamber is filled with a lipid emulsion, a second chamber with an amino acid solution and/or a third chamber with a glucose solution. This could, for example, be an electrolyte solution. The different components are only mixed together immediately before the bag is used by opening pull-open weld seams that separate the chambers from each other.

Such a bag is preferably designed as a film bag. In particular, an infusion bag is made of two films welded together.

The bag comprises at least two ports. The port can form the lower part of a connector, with the upper part fixing a sealing element with which the port is closed.

The upper part can comprise a break-off part. After breaking off the break-off part, the sealing element can be pierced with a needle or a spike to remove or inject liquid.

The connector can, for example, be designed to be connected to a transfer set. Removal generally takes place by inserting a spike which is connected to a transfer set or a transfer system.

The lower part can be welded into the bag, in particular in a transverse weld seam of the bag. For this purpose, the lower part can, for example, have an elongated, in particular boat-like, shape.

One connector is typically used to remove liquid, whereas another connector can optionally be used to add liquid, for example to transfer a drug into the medical liquid. The injection, for example of an active ingredient, can be carried out in particular by means of a needle syringe.

The installation has receptacles for holding the ports. According to one embodiment of the invention, the bag is gripped via the receptacles at the ports and then filled via the ports. After filling, the ports are closed with the upper part and are then sealed.

When filling a three-chamber bag, there is usually a blind port in addition to an injection port and a removal port. This is only used to fill the bag or a chamber of the bag. After filling, it is closed with a cap and a sealing element and is not used any further.

According to a preferred embodiment, the filling nozzle can be moved laterally by means of a drive. The drive can in particular be designed as an electric, pneumatic or hydraulic drive. According to this embodiment of the invention, an automated adjustment of the port spacing is made possible.

According to a preferred embodiment, the installation comprises one more receptacle for each port than there are filling nozzles. In particular, the installation can comprise five receptacles and four filling nozzles. The installation has a number of receptacles for each port that is at least one greater than the number of existing filling nozzles.

One, in particular exactly one, of the filling nozzles can be moved laterally. Preferably, this is a filling nozzle arranged on the outside in the order of the nozzles.

The filling nozzle can be moved in at least two, preferably exactly two, positions, with a receptacle for a port of the bag being arranged in the respective, preferably two, positions of the filling nozzle. The receptacle is preferably arranged below the filling nozzle.

In particular, the receptacles can be part of a receiving strip for the bag.

The receiving strip thereby has individual receptacles in the form of recesses adapted to the shape of the lower part of the port.

Preferably, the receptacle comprises a clamp for pressing the port closed, in particular the middle part or neck region of the port. In this embodiment, the port in this section is flexible and can therefore be clamped.

During the filling process, the clamp can serve as a valve to temporarily close the still open port.

For example, the bag can first be flooded with nitrogen before filling. The ports are closed by means of the clamps. The bag is then moved to the filling nozzles and the clamps are opened to fill the bag. Even after filling, the ports can be closed by means of the clamps until the port or ports are closed, in particular by placing the upper part on the lower part of the connector.

The clamp can in particular be part of a clamping strip.

In particular, the installation can comprise a receiving strip for receiving the ports. The ports are locked and held in place by means of a locking strip.

There may also be a movable clamping strip with which the ports are closed.

As described above, the installation is designed for aseptic filling. During the filling process, it is in particular intended that the ports are flushed with a protective gas, in particular nitrogen.

According to one embodiment, the filling nozzles are arranged on a head part which can be moved, in particular vertically, and/or the receptacles for the ports can be moved, in particular vertically.

Depending on the bag, the filling nozzles and the receptacles can be moved to a different spacing from one another, in particular vertically.

The installation can be designed as a rotary installation with a number of stations. For example, the bags can be received in a first station, gassed with nitrogen in a second station, filled in a third station and/or sealed in a fourth station.

The installation is preferably designed to fill at least three, preferably four, differently designed bags. Differently designed bags are bags with a different number and/or a different port spacing.

In particular, the installation can be designed for two different three-chamber bags as well as for three- and/or two-chamber bags. The chambers can have different volumes and/or be filled with different volumes.

The medical liquid is a liquid which is used for medical purposes and is preferably administered intravenously. In a preferred embodiment, the medicinal liquid is an infusion solution. Possible examples of such infusion solutions include
solutions, emulsions and/or suspensions containing nutrients for parenteral nutrition, in particular lipids, amino acids and/or glucose;
colloid solutions, in particular for blood replacement therapy (e.g. Voluven®); and/or
so-called premixed systems in which an active ingredient, e.g. paracetamol, has already been added to the medical liquid.

The invention also relates to the use of the installation described above for producing a bag filled with a medical liquid. In particular, the installation is used to produce an infusion bag filled with a parenteral nutrition composition.

The invention further relates to a method for aseptically filling bags with a medical liquid, in particular using the installation described above, with the method comprising the following steps:
providing a medical bag which has at least two ports via which the bag is filled with medical liquid by means of at least two filling nozzles, with at least one filling nozzle being moved laterally in order to adjust the spacing from another filling nozzle corresponding to the spacing between the at least two ports.

In particular, a first and a second medical bag can be provided, each having at least two ports via which the second bag is filled with medical liquid by means of the at least two filling nozzles, with the two ports of the first bag having a different spacing from one another than the ports of the second bag.

The method can be used in particular to fill two different three-chamber bags, of which two adjacent ports of one bag have a different spacing compared to the ports of the other bag.

To do this, the filling nozzle is moved from one receptacle to the other.

The first bag can be designed as a three-chamber bag and the second bag as a one- or two-chamber bag.

Preferably, the first and/or second bag is flooded with nitrogen before filling.

Furthermore, during filling of the first and/or second bag, the ports are preferably gassed with nitrogen.

According to one embodiment of the invention, the first bag and/or the second bag can also be evacuated before flooding with nitrogen.

After filling, the ports of the bag are closed with an upper part.

The bag can then be packaged with a secondary bag. The secondary bag can in particular be designed as a tear-open film packaging with sterile contents.

The invention further relates to the use of the method described above for producing a bag filled with a medical liquid. In particular, the method is used to produce an infusion bag filled with a parenteral nutrition composition.

### BRIEF DESCRIPTION OF THE DRAWINGS

The subject matter of the invention will be explained in more detail below with reference to the drawings FIG. 1 to FIG. 6.

FIG. 1 is a schematic view of a installation for filling a bag from the front.

FIG. 2 is a schematic view of the installation from above.

FIG. 3 shows a three-chamber bag and FIG. 4 a two-chamber bag.

Referring to FIG. 5, a schematic representation is shown to illustrate the use of the installation for different bags.

FIG. 6 is a flow chart of an exemplary embodiment of the method according to the invention.

### DETAILED DESCRIPTION OF THE DRAWINGS

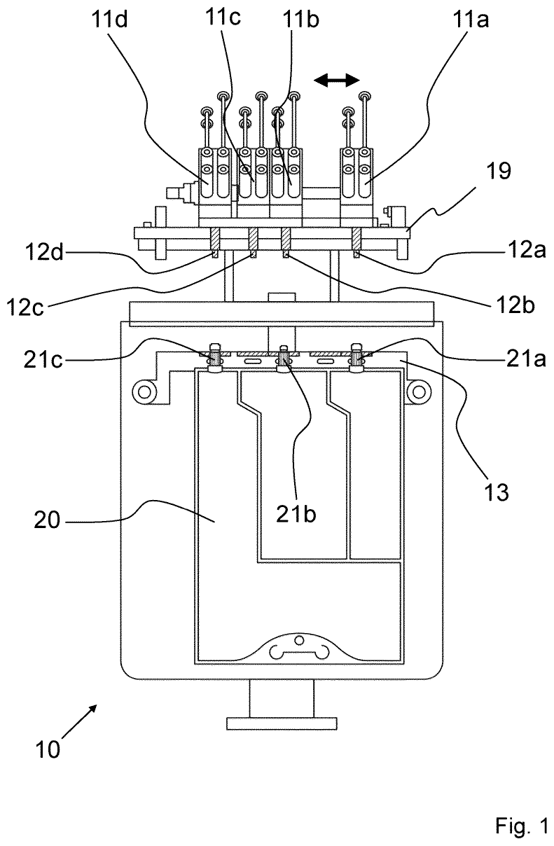

FIG. 1 shows a schematic view from the front of the components of an installation 10 for filling a bag 20.

The installation 10 comprises a head part 19 with a total of four valve blocks 11a-11d. Via the valve blocks 11a-11d, various components of a medical liquid, in particular a parenteral nutrition liquid, can be dosed or filled into the bag 20 via the filling nozzles 12a-12d using a corresponding hose system.

The head part 19 can be moved vertically together with the valve blocks 11a-11d.

A holder 13 for the bag 20 is located below the filling nozzles 12a-12d.

In this exemplary embodiment, the bag 20 is designed as a three-chamber bag with the connectors 21a and 21b as well as the blind port 21c.

The ports 27a-27c are designed as the lower parts 27a-27c of the connectors 21a, 21b and the blind port 21c.

The ports 27a-27c are held and clamped by the holder 13.

The holder 13 and the filling nozzles 11a-11d are then moved towards each other.

This can be done by raising the holder 13 and/or by lowering the head part 19 with the filling nozzles 12a-12d.

The filling nozzles 12a to 12d are immersed in the ports 27a-27c and the bag 20 can then be filled with, for example, three different components of a medical liquid. In one embodiment, the filling nozzles 12a to 12d are immersed in the ports 27a-27c or the filling nozzles 12a to 12d come into contact with the ports 27a to 27c in such manner that the filling process is shielded or sealed from the environment. The filling nozzles 12a to 12d are attached to the ports 27a to 27c in a sealed manner.

An outer, first filling nozzle 12a can be moved laterally together with the valve block 11a relative to the other three filling nozzles 12b-12d (see the double arrow marked in FIG. 1).

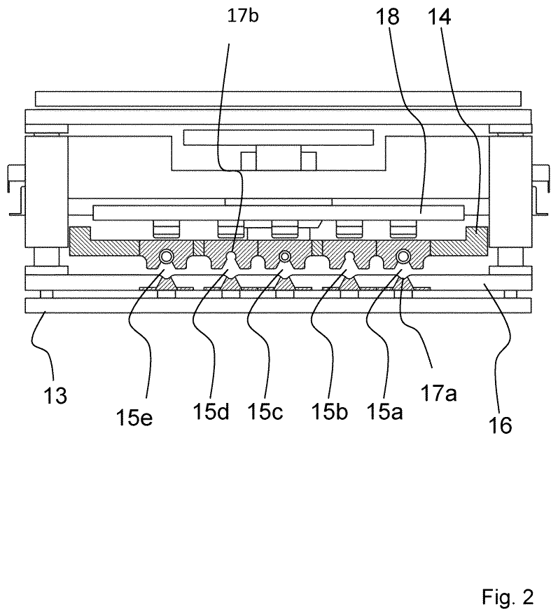

The lateral movement allows the first filling nozzle 12a to be moved to two different receptacles 15a, 15b for a port 21a (see FIG. 2).

In the view shown in FIG. 1, the displaceable filling nozzle 12a is in an outer position together with the valve block 11a.

For a bag 20d in which the ports 27a and 27b have a smaller spacing from one another, the filling nozzle 12a can be moved laterally in the direction of the filling nozzle 12b. The process is carried out, for example, by means of pneumatics.

FIG. 2 shows schematically the region of the holder 13 of the installation 10 for filling a bag 20.

The holder 13 comprises a receiving strip 14 for the bag 20.

A locking strip 16 is located opposite the receiving strip 14. The locking strip 16 and the receiving strip 14 can be moved towards each other. The recesses formed by the indentations 17a of the locking strip 16 and the indentations 17b of the receiving strip 14 are thereby closed.

The ports 27a-27c form a neck with which they are clamped in the recesses. In this example, a total of five receptacles 15a-15e are formed for the ports 27a to 27c. One receptacle 15a-15e is provided for each port 27a-27c.

According to this embodiment, the first filling nozzle 12a can be moved between the receptacle 15a and the receptacle 15b.

In order to press the lower part 27a-27c closed before and/or after filling, the holder 13 comprises the clamping strip 18, which can be moved relative to the receiving strip 14. The ports 27a to 27c can be pressed closed at the neck by means of the clamping strip 18. In this embodiment, the ports 27a to 27c each have a flexible, clampable region in their neck region.

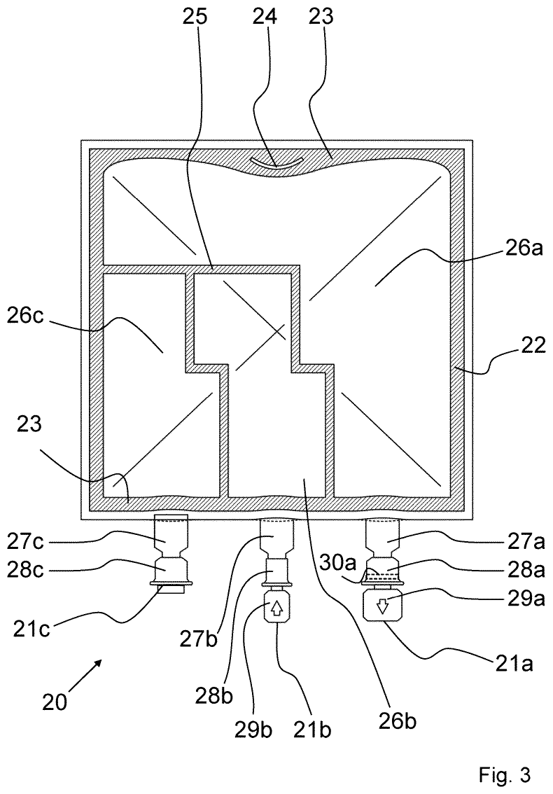

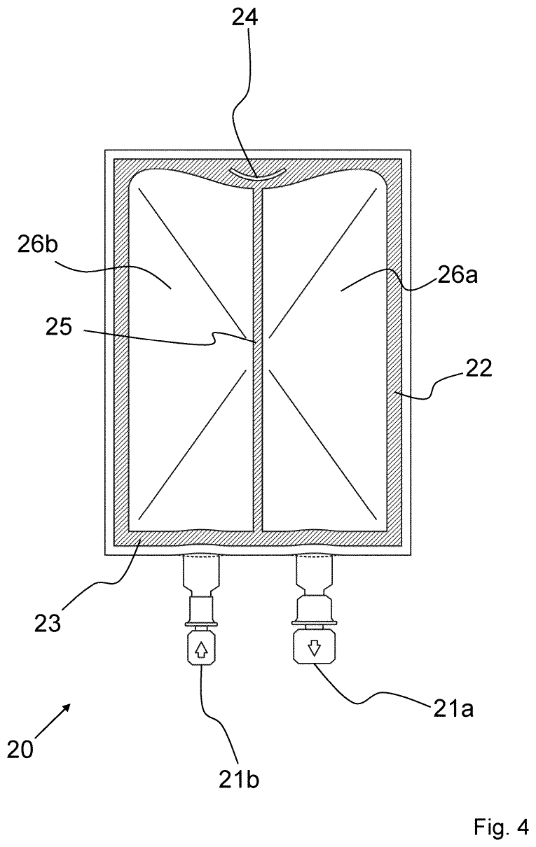

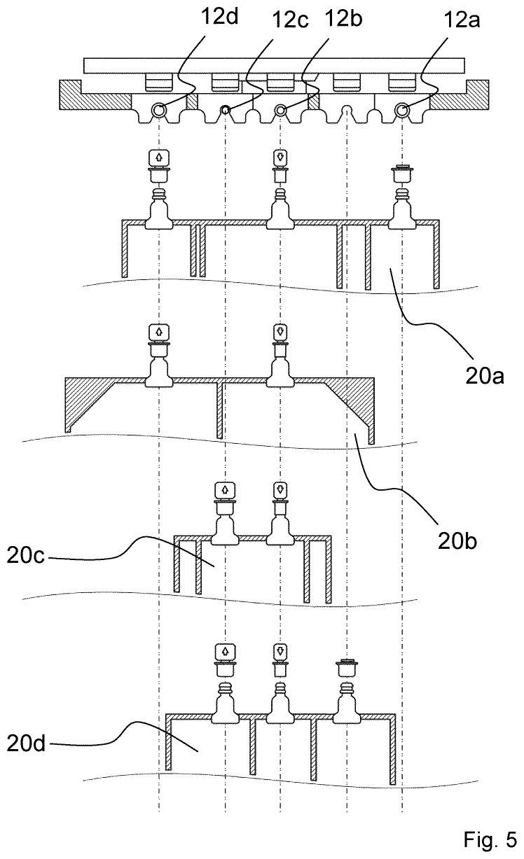

FIG. 3 shows a bag 20, which in this embodiment is designed as a three-chamber bag.

The bag is made of films welded via the longitudinal and transverse weld seams 22, 23. The bag 20 comprises a hanger 24 with which it can be suspended from a rack when the infusion solution contained in the bag 20 is removed.

The bag 20 is divided into three chambers 26a-26c via pull-open weld seams 25. For example, the individual components of a parenteral nutrition solution can be located in these chambers 26a-26c.

The three ports 27a-27c are welded into a transverse weld seam 23 of the bag. The ports 27a-27c each comprise a welded piece. The welded piece is the lower section of the port and forms a foot section. The previously mentioned flexible, clampable region is arranged between the welded piece and the head region of a port.

An upper part 28a to 28c is placed, in particular pressed, onto the lower part 27a-27c or the port 27a-27c in order to form a connector 21a-21b or a blind port 21c. A sealing element 30a (only represented schematically for the connector 27a) is pressed in between the lower part 27a to 27c and the upper part 28a to 28c.

The connector 21a is used for removal and the connector 21b is used for addition of liquid. The connector 20a and the connector 20b each have a break-off cap 29a, 29b. After removing the respective break-off cap 29a, 29b, the sealing element 30a can be pierced with a needle or a spike.

The port 27a can have a larger diameter than the port 27b, via which a liquid can be added in a smaller quantity, such as a medication. The port 27c serves only to fill the chamber 26c. The upper part 28c of the blind port 21c is therefore only designed as a closure cap without a break-off part.

The two-chamber bag represented in FIG. 4 is divided into the two chambers 26a, 26b by only one pull-open weld seam 25.

This bag is also designed as a film bag with longitudinal and transverse weld seams 22, 23 and a hanger 24.

The two-chamber bag 20 comprises only the two connectors 21a and 21b, of which the connector 21a serves as a removal port and the connector 21b as an injection port.

FIG. 5 shows schematically the flexible use of the installation 10 for filling a bag for differently designed bags 20a-20d. The installation 10 comprises the filling nozzles 12a to 12d.

The bag 20a is designed as a three-chamber bag. To fill the bag 20a, the first filling nozzle 12a is moved into the outer position. The bag 20a can thus be filled with the filling nozzles 12a, 12b and 12d. The filling nozzle 12c is not used for the bag 20a.

The bag 20b is a two-chamber bag whose removal and injection ports (27a, 27b) have the same spacing as in the bag 20a. This bag 20b can be filled by means of the filling nozzles 12b and 12d. The filling nozzles 12a and 12c are not used.

The single-chamber bag 20c has a smaller port spacing than the two-chamber bag 20b and the three-chamber bag 20d has a smaller port spacing to the adjacent port with respect to all ports than the bag 20a.

The bag 20c can be filled by using the adjacent filling nozzles 12b and/or 12c.

To fill the small three-chamber bag 20d, the first filling nozzle 12a is moved laterally into its inner position in the direction of the filling nozzle 12c. The small three-chamber bag 20d, which may be intended in particular for paediatric use, can now be filled via the filling nozzles 12a, 12b and 12c.

The installation 10 can therefore fill at least four bags with different port configurations.

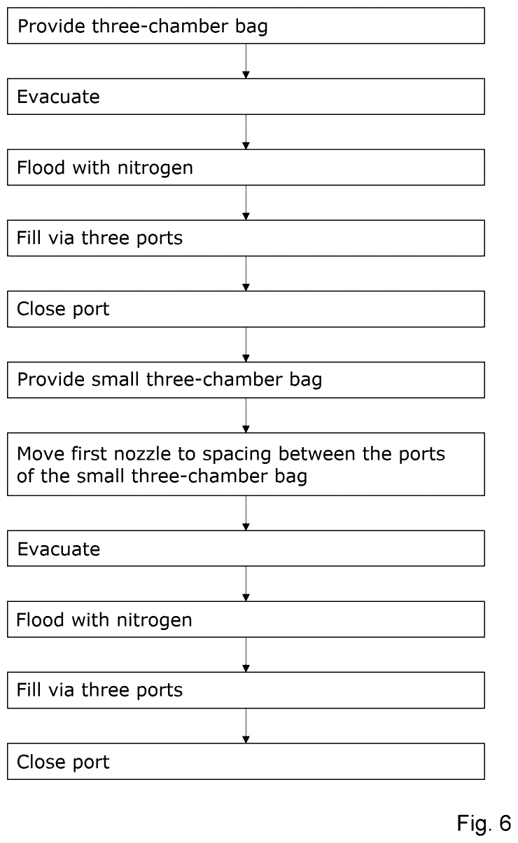

FIG. 6 shows the method steps according to an exemplary embodiment of the invention.

First, a three-chamber bag 20a is provided, which is to be filled, for example, with a parenteral nutrition solution for an adult.

The bag 20 is first evacuated and then flooded with nitrogen.

The three-chamber bag 20a is then filled via three ports 27a-27c, with the ports 27a-27c being gassed with an inert gas, for example nitrogen, during filling. This creates a local atmosphere around the filling region.

The ports 27a-27c of the three-chamber bag are then closed.

The installation 10 is then to be used to fill a three-chamber bag 20d, which is smaller than the three-chamber bag 20a described above and in which all three ports 27a-27c are each located closer to an adjacent port.

For this purpose, the first filling nozzle 12a is moved inwards. It is now located at the further inner receptacle 15b. Here, the port 27c is filled (see also FIG. 3 in conjunction with FIG. 5).

The smaller spacing between the other two ports 27a and 27b (see FIG. 3 in conjunction with FIG. 5) is compensated by the fact that they are now located at the receptacles 15c and 15d, whereas the receptacle 15e remains free (see FIG. 2).

The smaller three-chamber bag 20d is also preferably evacuated, flooded with nitrogen, filled via the three ports 27a-27c and lastly closed.

The invention provides an installation with which multi-chamber bags with different volumes and/or with a different port spacing can be filled in a very flexible manner.

### LIST OF REFERENCE NUMERALS

10 Installation for filling a bag
11a-11d Valve block
12a First filling nozzle
12b Second filling nozzle
12c Third filling nozzle
12d Fourth filling nozzle
13 Holder
14 Receiving strip for the bag
15a-15e Receptacle for one port
16 Locking strip
17a,17b Indentation
18 Clamping strip
19 Head part
20 Bag
20a-20d Bag
21a Connector/removal connector
21b Connector/injection connector
21c Blind port
22 Longitudinal weld seam
23 Transverse weld seam
24 Hanger
25 Pull-open weld seam
26a-26c Chamber
27a-27c Port/lower part of the connector or blind port
28a-28c Upper part
29a-29b Break-off cap
30a Sealing element

1. A system for filling a bag with a medical liquid, the installation comprising:
a first filing nozzle, wherein the first filing nozzle is configured to fill a first component of the medical liquid into the bag via a first port of the bag; and
a second filling nozzle laterally spaced from the first filing nozzle, wherein the second filling nozzle is configured to fill a second component of the medical liquid into the bag via a second port of the bag,
wherein the first filling nozzle is configured to be moved laterally relative to the second filling nozzle.

2. The system of claim 1, wherein the first filling nozzle is configured to be moved laterally using a drive.

3. The system of claim 1, further comprising a number of receptacles, wherein each of the receptacles is configured to receive a port of the bag, and wherein the number of receptacles is at least one greater than a number of filling nozzles.

4. The system of claim 1, wherein only the first filling nozzle is configured to be moved laterally.

5. The system of claim 1, wherein:
the first filling nozzle is configured to be moved to at least two positions,
the installation further comprises a plurality of receptacles, and
each of the plurality of receptacles is arranged at one of the at least two positions.

6. The system of claim 1, wherein the installation further comprises a plurality of receptacles, and wherein each of the receptacles comprises a clamp for pressing a port of the bag closed.

7. The system of claim 1, wherein the filling is aseptic filling.

8. The system of claim 1, wherein the installation is a rotary installation.

9. The system of claim 1, wherein the first filling nozzle and the second filling nozzle are arranged on a head of the bag that is configured to be moved vertically relative to a plurality of receptacles of the installation.

10. The system of claim 1, wherein the installation is configured to fill at least three different bags that each have a different number of ports, and wherein the ports of each of the different bags are spaced apart from one another by different distances.

11. Use of the system of claim 1, for filling an infusion bag with a parenteral nutrition composition.

12. A method for aseptically filling a bag with a medical liquid, the method comprising:
providing the bag comprising a first port and a second port;
laterally moving a first filling nozzle relative to a second filling nozzle to adjust the spacing between the first filling nozzle and the second filling nozzle to correspond to the spacing between the first port and the second port of the bag;
filing a first component of the medical liquid into the bag using the first filing nozzle that is in fluid communication with the first port; and
filing a second component of the medical liquid into the bag using the second filing nozzle that is in fluid communication with the second port.

13. The method of claim 12, wherein the bag defines a first chamber that is in fluid communication with the first port and a second chamber that is in fluid communication with the second port.

14. The method of claim 12, further comprising:
flooding the bag with nitrogen before filling the first component of the medical liquid and filling the second component of the medical liquid; and/or
gassing the first port and the second port with nitrogen during filling the first component of the medical liquid and filling the second component of the medical liquid.

15. The method of claim 12, further comprising closing the first port and the second port with a sealing element.

16. The method of claim 15, further comprising packaging the filled bag within a secondary package.

17. The system of claim 1, wherein the bag defines a first chamber that is in fluid communication with the first port and a second chamber that is in fluid communication with the second port.

18. The system of claim 1, further comprising a third filling nozzle laterally spaced apart from the first filling nozzle and the second filling nozzle.

19. The system of claim 1, further comprising a plurality of receptacles configured to be moved vertically relative to the first filling nozzle and the second filling nozzle arranged on a head of the bag.

20. The system of claim 2, The installation of claim 2, wherein the drive is an electric drive, a pneumatic drive, or a hydraulic drive.
